(19) United States
(12) Patent Application Publication
(10) Pub. No.: US 2009/0328211 A1
(43) Pub. Date: Dec. 31, 2009

(54) CONTROL FLOW DEVIATION DETECTION FOR SOFTWARE SECURITY

(76) Inventors: Jacob A. Abraham, Austin, TX (US); Ramtilak Vemu, Austin, TX (US)

Correspondence Address: Ballard Spahr LLP, SUITE 1000, 999 PEACHTREE STREET, ATLANTA, GA, 30309-3915, US

(21) Appl. No.: 12/484,839

(22) Filed: Jun. 15, 2009

Related U.S. Application Data
(60) Provisional application No. 61/061,279, filed on Jun. 13, 2008.

(51) Int. Cl. G06F 11/00

(52) U.S. Cl. 726/22

(57) ABSTRACT

Provided are methods and systems for control flow deviation detection. Provided are methods for software security, comprising executing a software program, generating a run-time signature variable, updating the run-time signature variable as the software program executes, comparing the run-time signature variable with a pre-computed signature, and detecting a deviation in control flow of the software program based on the comparison between the run-time signature variable and the pre-computed signature.

### CROSS REFERENCE TO RELATED PATENT APPLICATION

This application claims priority to U.S. Provisional Application No. 61/061,279 filed Jun. 13, 2008, herein incorporated by reference in its entirety.

### SUMMARY

Provided are methods and systems for control flow deviation detection. In an aspect, provided are methods, systems, and computer readable media for software security, comprising executing a software program, generating a run-time signature variable, updating the run-time signature variable as the software program executes, comparing the run-time signature variable with a pre-computed signature, and detecting a deviation in control flow of the software program based on the comparison between the run-time signature variable and the pre-computed signature.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2A depicts sample software code which can be protected against security attacks deviating the control flow;

FIG. 2B depicts a control flow graph of the program in FIG. 2A and an example illegal jump of the type induced by security attacks;

FIG. 3 depicts an exemplary application of the methods and systems provided as applied to the program in FIG. 2A and detection of an example illegal jump of the type induced by security attacks; and

FIG. 4 illustrates an exemplary method of operation.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

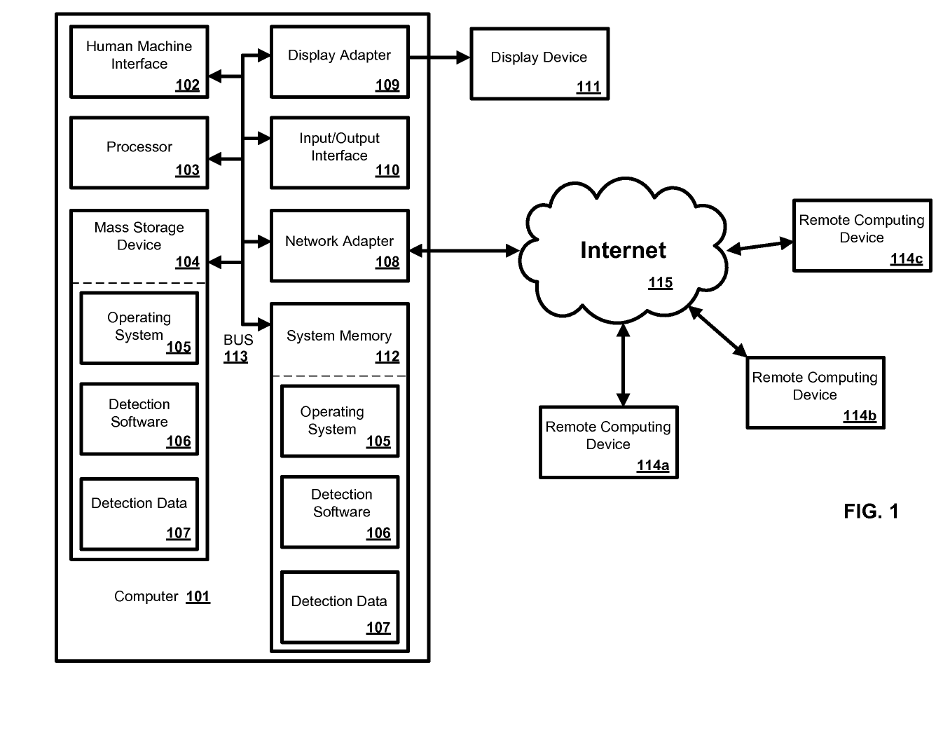

FIG. 1 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, consumer electronics, embedded systems, automated teller machines, multiprocessor systems, and the like. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, detection software 106, detection data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as detection data 107 and/or program modules such as operating system 105 and detection software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and detection software 106. Each of the operating system 105 and detection software 106 (or some combination thereof) can comprise elements of the programming and the detection software 106. Detection data 107 can also be stored on the mass storage device 104. Detection data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of detection software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In an aspect, provided are methods and systems that provide a protection technique wherein security attacks which deviate control flow of a software program can be detected before causing any damage. In another aspect, provided are methods and systems that provide a protection technique wherein it is not necessary to remove all flaws in a software program that can be exploited by the security attacks. In a further aspect, provided are methods and systems for protecting software against attacks which are generic enough so that the methods and systems can be implemented at one or all levels of programming, i.e. at high, intermediate and machine level languages.

In an aspect provided are methods and systems that ensure that a control flow specification as specified by the software is followed before executing critical operations. A control flow specification represents the correct execution order of components in a software program. A pre-computed signature can be generated that can be a unique value that represents a correct position of execution in the control flow specification. A run-time signature variable can be generated and maintained that comprises a signature value. As the program executes, the signature value for a current point of execution can be generated, for example, at one or more of, an origin function, a destination function, an intermediary function, and the like. There will be a mismatch between the run-time signature variable and the pre-computed signature for the current point of execution if there is an attack which deviates the control flow of the program. A check of the value of the run-time signature variable can determine if an attack has occurred. In an aspect, redundant code for continuously updating the run-time variable and to check its value can be added to the software statically.

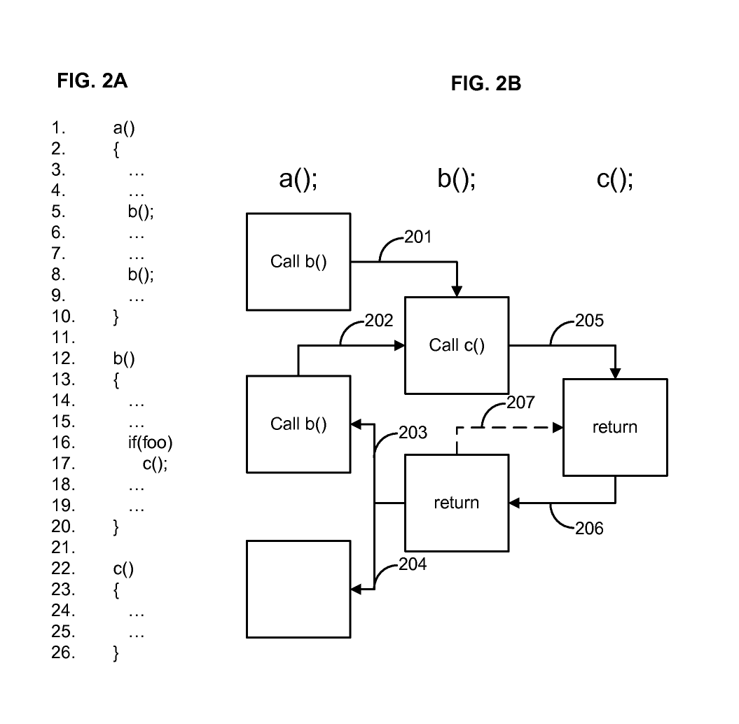

FIG. 2A shows a sample software code fragment which can be executed on a computing system to which the present methods and systems can be applied. Though the example shows software code written in C, the methods and systems are applicable to any high-level, intermediate-level as well as machine-level language. The software code can be demarcated through function boundaries. The present methods and systems are not restricted to functions. The present methods and systems can be applied to other software entities such as procedures, programs, processes, or even arbitrary sections of code with a single entry point and a single exit point.

The exemplary code shown in the FIG. 2A has three functions—functions a, b, and c. Function b is called twice from function a (lines 5 and 8). Function c is called once from the function b (line 17) when the variable foo is true. Though the functions shown have no input or output parameters, the present methods and systems can be applied to any function.

FIG. 2B shows a control flow graph of the code fragment in FIG. 2A. The control flow graph comprises nodes and edges. The nodes (boxes) represent sections of code for which control will remain in the same function. The edges (directed arrows) represent legal transfer of control between nodes. As used herein, “legal transfer” refers to the transfer of control according the software program. In FIG. 2B, edges numbered 201 and 203 represent the call to function b in line 5 of FIG. 2A and the corresponding return. Similarly, edges numbered 202 and 204 represent the call and return to function b in line 8. Edges numbered 205 and 206 represent the call and return to function c in line 17.

FIG. 2B also shows an example illegal jump 207 (dashed edge). Due to a security attack, the control is transferred to the function c instead of returning to function a. The security of the computing system may be compromised in the event of such an attack. For example, the function c may be called even when foo is false. Such an event is not possible under normal functioning of the program. The present methods and systems can detect such illegal jumps.

In an aspect, a runtime signature variable can be maintained. As used herein, the variable can be referred to as S. In an aspect, different memory storage areas can be used to carry S. For example, a dedicated architectural register can be used or a dedicated memory slot can be used. In a further aspect, the storage area of S is not fixed and can vary with the execution of code.

Extra code can be inserted into a software program to continuously update the runtime signature variable S. As a result of the continuous updates, the value of S can reflect a point of execution in the code if there is no attack. If there is an attack, whereby control flow of the program is deviated, there will be a mismatch between the value of S and the current point of execution. Thus, if the value of S is checked and compared to the current point of execution, such attacks can be detected. Determining the whether the run-time signature variable matches the current point of execution can be performed at one or more points in the. For example, S can be checked for correctness at one or more of, immediately after every update of S, before and/or after security critical operations (such as system calls) in the software, and the like.

Once a security attack is detected, recovery actions can be performed. If the attack is detected at a check of S immediately after a critical operation, there is a possibility that the operation has been illegally performed. The recovery action performed can take this into account.

In an aspect, execution of arbitrary code can be prevented. Illegal jumps to code which do not have runtime signature variable checks contained within the code are not detected by the present methods and systems. In an aspect, a check can be implemented before each control instruction in the code to determine if the destination of the control transfer is within the code which comprises signature checks. In another aspect, the present methods and systems can prevent execution of code in a stack region of a processor.

Next, some example embodiments are provided. In these example embodiments, S is updated such that it will have a pre-computed value at each point in the program if there is no attack. A mismatch between S and the pre-computed value at a point in the program will indicate a deviation in control flow due to a security attack. For the purpose of explanation, let the software have m functions—f1, f2, . . . fm. Let a function fi be called from ni places in the program, i.e., there are ni calls of fi function in the program. Let ci_j denote the jth call of the function fi and let ri_j denote the corresponding return from fi.

The signature variable will have the following contents depending on the execution point of the program.
S=Sf_i when the program is executing function fi.
S=Sc_i_j on the jth call to the function fi.
S=Sr_i_j on the return from the jth call of the function fi.

By way of example, signature variable update instructions can be inserted in the program according to the example embodiment as follows:
Update instructions are inserted at the beginning of each function. Let Ub_i represent the update instructions inserted at the beginning of the function fi.
Update instructions are inserted at the end of each function. Let Ue_i represent the update instructions inserted at the beginning of the function fi.
Update instructions are inserted immediately before the call instruction of any function. Let Uc_i_j represent the instructions inserted immediately before the jth call of the function fi.
Update instructions are inserted immediately after the call instruction of any function. Let Ur_i_j represent the instructions inserted immediately after the return from the jth call of the function fi.

The signatures and the update instructions may have the following properties.

Soundness Properties:
Uc_i_j(S)=Sc_i_j if S=Sf_i
Ur_i_j(S)=Sf_i if S=Sr_i_j
Ub_i(S)=Sf_i if SEε{Sc_i_1, Sc_i_2, . . . Sc_i_ni}
Ue_i(S)εE {Sr_i_1, Sr_i_2, . . . Sr_i_ni} if S=Sf_i

Completeness Properties:
Uc_i_j(S)≠Sc_i_j if S≠Sf_i
Ur_i_j(S)≠Sf_i if S≠Sr_i_j
Ub_i(S)≠Sf_i if Sε{Sc_i_1, Sc_i_2, Sc_i_ni}
Ue_i(S)ε{Sr_i_1, Sr_i_2, . . . Sr_i_ni)} if S≠Sf_i

Some aspects of the methods and systems provided may satisfy the completeness properties only partially. In such aspects, there exists a possibility of an attack.

In an aspect of the methods and systems provided, one or all runtime signature values assigned can be unique. In a further aspect, a subportion of the runtime signature values can be assigned the same value. For example, in an aspect, Sr_i_j can be the same value for all j for a given i. S can be the same value when returning from the function fi irrespective of where the function is called from.

In some aspects, update instructions can be directly inserted into the code. In a further aspect, a customized application programming interface (API) can be used and the API called for updating and checking the values of S.

In an aspect, the code required for inserting the update and checking instructions of S can be inserted at the high-level, intermediate-level, and/or and machine-code level.

The completeness property can be used to detect illegal jumps resulting from security attacks. Due to an illegal jump, the contents of the runtime signature variable immediately after the jump are different from the expected signature values at that point. This difference between the contents of the signature variable and the expected values can be maintained throughout the program due to the completeness property of the signature updates. Hence, a check of the signature values at any point can detect the attack.

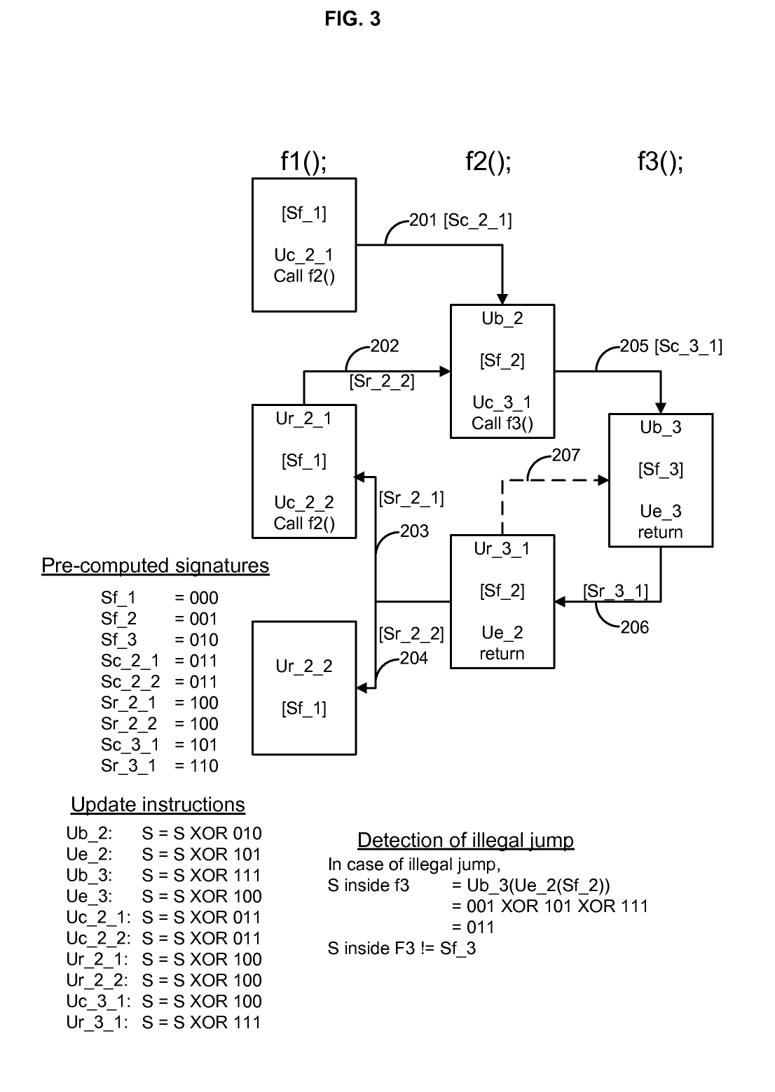

FIG. 3 shows an exemplary application of the methods and systems on the software code fragment from FIG. 2A. For ease of explanation, functions a, b, and c are renamed as functions f1, 2, and f3 respectively. The expected values (pre-computed signatures) of S at each point in the code fragment are calculated and are shown within square brackets inside the function blocks and associated with each connecting arrow. These are the values S will have at the corresponding point in the code fragment if there is no attack. For example, S is expected to have a value of Sf_1 (000) in the function f1. Similarly, S is expected to have a value of Sc_2_1 (011) on the first call of f2 function and a value of Sr_2_1 (100) on the corresponding return. At any point in the program, S can be checked to see if it is equal to the expected value at that point.

FIG. 3 also shows exemplary signature update code that needs to be inserted. The code required for updating S can be constructed such that the updates follow the soundness and completeness properties stated above. If S has a value of Sf_1 in the first node in function f1, S will have values equal to the expected values at each point in the program if there is no attack. For example, if S has a value of Sf_1 (000) in the first node in functions, S will have a value of Sc_2_1 (011) when the function f2 is called for the first time due to the update statement Uc2_1(S=S XOR 011). Similarly, S will have a value of Sf_2 (001) inside the function f2 due to the update statement Ub_2 (S=S XOR 010). The other edges can be similarly followed through to see that S will have its expected value at each point in the program. This is due to the soundness property of the update statements.

It can also be seen in FIG. 3 that the update statements are complete, i.e. S will have the expected value immediately after an update only if S has the expected value immediately before the update. For example, S will have the expected value Sc_2_1 (011) immediately after the update statement Uc2_1(S=S XOR 011) only if S has a value Sf_1 (000) immediately before the update.

An exemplary illegal jump is also shown in FIG. 3. Due to the illegal jump, control will transfer to function f3 from the end of f2 instead of returning to the point from which f2 is called in f1. Let there be a check of the value of S after each update. Hence, just before the illegal jump, S will have its expected value Sr_2_1 or Sr_2_2 (100), since no error has been detected until the illegal jump. As a result of the illegal jump, control is transferred to the function f3 and the update instruction Ub_3 is executed. After the update instruction, S will have a value of 011 (100 XOR 111). Immediately after the update instruction, S is checked if its value is equal to Sf_3 (010). Since, it is not, an error is flagged. Appropriate actions can be undertaken if an error is flagged.

The illegal jump may also have been to the middle of the function f3, whereby the illegal jump will bypass the check that takes place at the beginning of the function. Such an error is only detected at the end of the function by the check which can be placed immediately after the update instruction Ue_3. Attacks which trigger such illegal jumps can be prevented from causing damage by placing checks immediately before and after sensitive operations inside function f3.

In the example shown in FIG. 3, the signature update code comprises XOR operations. Other aspects can use other types of operations for updating signatures. The signature update code in the example can be directly inserted in the program. In other aspects, an API can be used for updating the signature.

S shown in the FIG. 3 comprises three bits. In practice, S can comprise any number of bits. S can be maintained easily if S has the same width as that of (or a multiple of) an architectural register or if S has the size of (or a multiple of) an integer or any other commonly used data type.

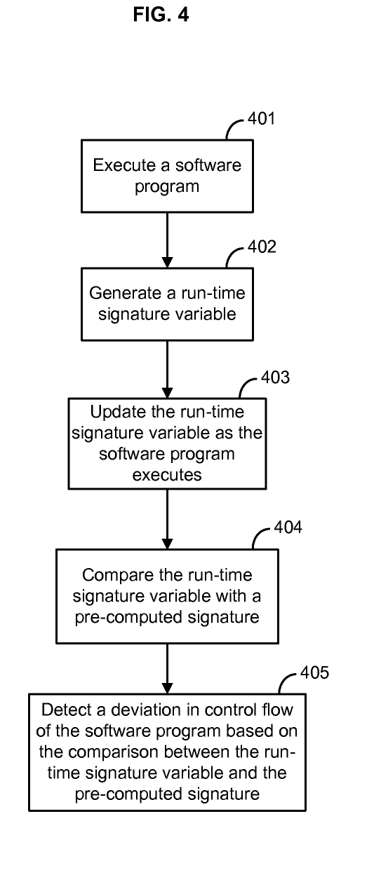

In an aspect, illustrated in FIG. 4, provided are methods for software security, comprising executing a software program at 401, generating a run-time signature variable at 402, updating the run-time signature variable as the software program executes at 403, comparing the run-time signature variable with a pre-computed signature at 404, and detecting a deviation in control flow of the software program based on the comparison between the run-time signature variable and the pre-computed signature at 405.

Updating the run-time signature variable as the software program executes can comprise receiving a signature value for a current point of execution in the software program and storing the signature value as the run-time signature variable.

The current point of execution can be one or more of, a beginning of a function, an end of a function, immediately before a call instruction, and immediately after a call instruction.

Code for updating the signature variable can be inserted into the software program statically. Code for updating the signature variable can be inserted into the software program at one or more of, a beginning of a function, an end of a function, immediately before a call instruction, and immediately after a call instruction.

The pre-computed signature can be generated prior to executing the software program. The pre-computed signature can represent an expected value for the run-time signature variable based on a control flow of the software program.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for software security, comprising:
executing a software program;
generating a run-time signature variable;
updating the run-time signature variable as the software program executes;
comparing the run-time signature variable with a pre-computed signature; and
detecting a deviation in control flow of the software program based on the comparison between the run-time signature variable and the pre-computed signature.

2. The method of claim 1, wherein updating the run-time signature variable as the software program executes comprises:
receiving a signature value for a current point of execution in the software program; and
storing the signature value as the run-time signature variable.

3. The method of claim 2, wherein the current point of execution can be one or more of, a beginning of a function, an end of a function, immediately before a call instruction, and immediately after a call instruction.

4. The method of claim 1, wherein code for updating the signature variable is inserted into the software program statically.

5. The method of claim 1, wherein code for updating the signature variable is inserted into the software program at one or more of, a beginning of a function, an end of a function, immediately before a call instruction, and immediately after a call instruction.

6. The method of claim 1, wherein the pre-computed signature is generated prior to executing the software program.

7. The method of claim 6, wherein the pre-computed signature represents an expected value for the run-time signature variable based on a control flow of the software program.

8. A computer readable medium having computer executable instructions for performing a method for software security, wherein the computer executable instructions comprise computer executable code portions for:
executing a software program;
generating a run-time signature variable;
updating the run-time signature variable as the software program executes;
comparing the run-time signature variable with a pre-computed signature; and
detecting a deviation in control flow of the software program based on the comparison between the run-time signature variable and the pre-computed signature.

9. The computer readable medium of claim 8, wherein updating the signature variable as the software program executes comprises:
receiving a signature value for a current point of execution in the software program; and
storing the signature value as the run-time signature variable.

10. The computer readable medium of claim 9, wherein the current point of execution can be one or more of, a beginning of a function, an end of a function, immediately before a call instruction, and immediately after a call instruction.

11. The computer readable medium of claim 8, wherein code for updating the signature variable is inserted into the software program statically.

12. The computer readable medium of claim 8, wherein code for updating the signature variable is inserted into the software program at one or more of, a beginning of a function, an end of a function, immediately before a call instruction, and immediately after a call instruction.

13. The computer readable medium of claim 8, wherein the pre-computed signature is generated prior to executing the software program.

14. The computer readable medium of claim 13, wherein the pre-computed signature represents an expected value for the run-time signature variable based on a control flow of the software program.

15. A system for software security, comprising:
a memory, configured for storing a software program, a run-time signature variable, and a pre-computed signature; and
a processor, coupled to the memory, configured for
executing the software program,
generating the run-time signature variable,
updating the run-time signature variable as the software program executes,
comparing the run-time signature variable with the pre-computed signature, and
detecting a deviation in control flow of the software program based on the comparison between the run-time signature variable and the pre-computed signature.

16. The system of claim 15, wherein updating the signature variable as the software program executes comprises:
receiving a signature value for a current point of execution in the software program; and
storing the signature value as the run-time signature variable.

17. The system of claim 16, wherein the current point of execution can be one or more of, a beginning of a function, an end of a function, immediately before a call instruction, and immediately after a call instruction.

18. The system of claim 15, wherein code for updating the signature variable is inserted into the software program at one or more of, a beginning of a function, an end of a function, immediately before a call instruction, and immediately after a call instruction.

19. The system of claim 15, wherein the pre-computed signature is generated prior to executing the software program.

20. The system of claim 19, wherein the pre-computed signature represents an expected value for the run-time signature variable based on a control flow of the software program.
